(19) United States
(12) Patent Application Publication
(10) Pub. No.: US 2018/0144292 A1
(43) Pub. Date: May 24, 2018

(54) APPARATUS AND METHOD FOR TRACKING CONSUMER PREMISES INVENTORY

(71) Applicant: Wal-Mart Stores, Inc., Bentonville, AR (US)

(72) Inventors: Todd D. Mattingly, Bentonville, AR (US); Donald R. High, Noel, MO (US); Robert J. Taylor, Rogers, AR (US); David Tovey, Rogers, AR (US)

(21) Appl. No.: 15/818,112

(22) Filed: Nov. 20, 2017

Related U.S. Application Data
(60) Provisional application No. 62/425,455, filed on Nov. 22, 2016.

(51) Int. Cl. G06Q 10/08; G06F 17/30

(52) U.S. Cl. CPC G06Q 10/087; G06F 17/30964

(57) ABSTRACT

Systems, apparatuses, and methods are provided herein for consumer premises inventory tracking. A system for consumer premises inventory tracking comprises an inventory sensor coupled to an inventory tracking device configured to detect changes in an inventory associated a premises comprising a plurality of inventory tracking devices, a communication device configured to communicate with a plurality of other inventory tracking devices, and a control circuit coupled to the inventory sensor and the communication device, the control circuit being configured to: detect a change in the inventory via the inventory sensor, determine a purchase order based on the change in the inventory, determine whether to automatically submit the purchase order to a remote server based on direct communications with the plurality of other inventory tracking devices via the communication device, and submit the purchase order to the remote server.

### CROSS-REFERENCE TO RELATED APPLICATION

This application claims the benefit of the following U.S. Provisional Application No. 62/425,455 filed Nov. 22, 2016, which is incorporated herein by reference in its entirety.

### TECHNICAL FIELD

This invention relates generally to home appliances.

### BACKGROUND

A home typically includes a number of storage areas for household items, including perishables and consumables. These products may stay in the storage area for a period of time before they are used.

### BRIEF DESCRIPTION OF THE DRAWINGS

Disclosed herein are embodiments of apparatuses and methods for tracking consumer premises inventory. This description includes drawings, wherein:

FIG. 1 comprises a system diagram of an overall system in accordance with several embodiments;

FIG. 2 comprises a flow diagram of a method in accordance with several embodiments;

FIG. 3A comprises a flow diagram of a method in accordance with several embodiments;

FIG. 3B comprises a flow diagram of a method in accordance with several embodiments;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings;

FIG. 9 comprises a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for consumer premises inventory tracking comprises. A system for consumer premises inventory tracking comprises an inventory sensor coupled to an inventory tracking device configured to detect changes in an inventory associated a premises comprising a plurality of inventory tracking devices, a communication device configured to communicate with a plurality of other inventory tracking devices, and a control circuit coupled to the inventory sensor and the communication device, the control circuit being configured to: detect a change in the inventory via the inventory sensor, determine a purchase order based on the change in the inventory, determine whether to automatically submit the purchase order to a remote server based on direct communications with the plurality of other inventory tracking devices via the communication device, and submit the purchase order to the remote server.

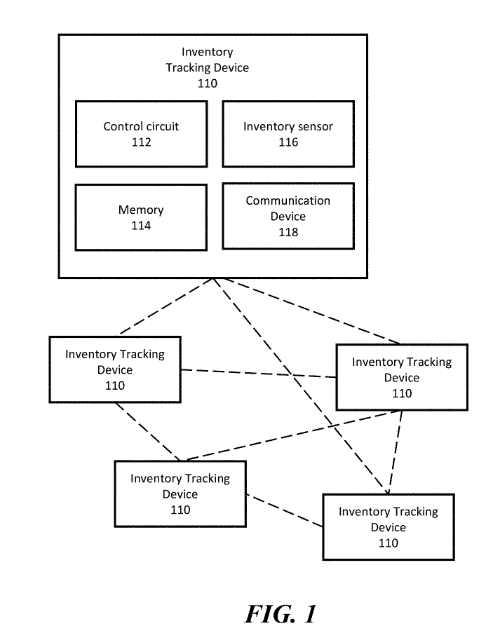

Referring now to FIG. 1, a system for tracking consumer premises inventory is shown. The system includes a plurality of inventory tracking devices 110 configured to communicate with each other. In some embodiments, an inventory tracking device 110 comprises one or more of a smart appliance, a smart shelf, a smart receptacle, and an inventory tracking attachment coupled to a storage space at a location. In some embodiments, a smart appliance may comprise an appliance with sensors, processing capability, and networking/communication capability. In some embodiments, a smart appliance may comprise one or more of a smart refrigerator, a smart stove, a smart oven, a smart cupboard, a smart microwave, a smart washer, etc. In some embodiments, an inventory tracking device 110 may comprise a standalone device that may be coupled to a conventional storage and/or usage space such as a cupboard, a pantry, a shelf, a countertop, etc. In some embodiments, the inventory tracking device 110 may comprise an Internet of Thing (IOT) device.

An inventory tracking device 110 at the consumer premises comprises a control circuit 112, a memory 114, an inventory sensor 116, and a communication device 118. In some embodiments, the control circuit 112, the memory 114, the inventory sensor 116, and the communication device 118 may comprise a discrete device enclosed in a housing. In some embodiments, the inventory tracking device 110 may comprise other components such as a container, a storage space, and/or other electrical and/or mechanical components of a smart appliance.

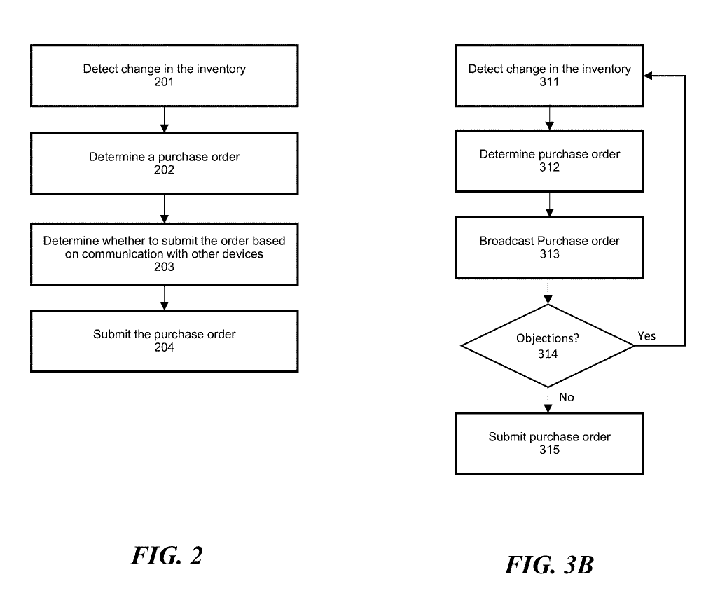

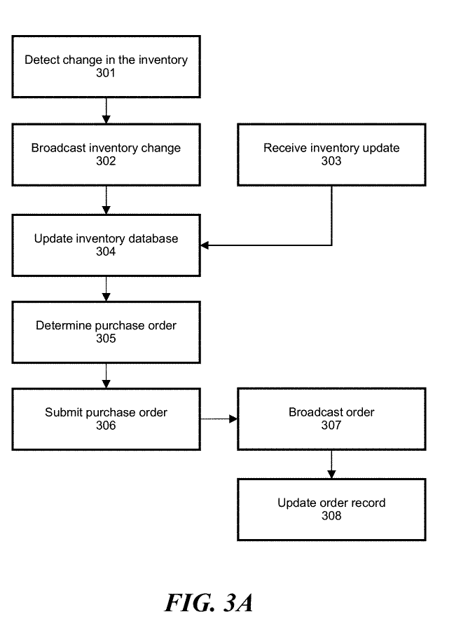

The control circuit 112 may comprise a processor, a microprocessor, and the like and may be configured to execute computer readable instructions stored on a computer readable storage memory 114. The computer readable storage memory 114 may comprise volatile and/or non-volatile memory and have stored upon it a set of computer readable instructions which, when executed by the control circuit 112, causes the control circuit 112 to monitor the consumer premises inventory using the inventory sensor 116 and determine whether to submit an order via the communication device 118 based on inventory changes. In some embodiments, the control circuit 112 may further be configured to communicate with other inventory tracking devices 110 by broadcasting messages and/or responding to inquiries. In some embodiments, the memory 114 may further be configured to store a copy of a shared ledger stored on a plurality of inventory tracking devices 110 in the system. In some embodiments, the shared ledger may comprise distributed database and/or a blockchain for recording inventory levels, inventory changes, and/or purchase orders associated with a group of inventory tracking devices 110 associated with a consumer premises. In some embodiments, the memory 114 may further store instruction for running a smart appliance comprising the inventory tracking device 110. In some embodiments, the computer executable instructions may cause the control circuit 112 of the inventory tracking device 110 to perform one or more steps in the methods and processes described with reference to FIGS. 2 and 3A-B herein.

The inventory sensor 116 may comprise a sensor configured to detect for inventory changes at the consumer premises. In some embodiments, the inventory sensor 116 may comprise one or more of a camera, an optical sensor, a barcode reader, a Radio Frequency Identification (RFID) reader, a weight sensor, and the like. In some embodiments, the inventory sensor 116 may be configured to detect items added and/or removed from a space monitored by the inventory sensor 116. For example, an inventory sensor 116 of a smart refrigerator may be configured to capture images of its interior to detect for changes in the content of the refrigerator. In another example, an inventory sensor coupled to a cereal container may be configured to weight its content to detect for consumption of cereal. In yet another example, a smart trash can may be configured to monitor for items that are thrown away to detect for items that are removed from the inventory at the consumer premises. In some embodiments, the inventory sensor 116 may be configured to detect for items used in a space monitored by the inventory sensor 116. For example, a cutting board or a stove top comprising an inventory sensor 116 may be configured determine what items have been removed from the inventory and used to prepare a meal. In another example, a smart washing machine may be configured to detect for the amount of detergent used to run the washing machine over time with an inventory sensor 116.

The communication device 118 may comprise a device that allows inventory tracking devices 110 to communicate with each other. The communication device 118 may comprise one or more of a Bluetooth transceiver, an ANT+ transceiver, an infrared (IrDA) transceiver, an optical transceiver, ZigBee transceiver, Z-Wave transceiver, a Wi-Fi transceiver, an RFID transceiver, a radio frequency transceiver, etc. In some embodiments, the inventory tracking devices 110 may be configured to communicate directly with each other wirelessly without an intermediary device. In some embodiments, the inventory tracking devices 110 may be configured to communicate via a network switch and/or a router that only forwards the communication without interpreting or processing the content of the messages. In some embodiments, one or more of the inventory tracking devices 110 may be configured to relay and/or repeat messages to other devices. In some embodiments, the inventory tracking devices 110 may be configured to communicate with each other without a central hub that interprets, processes, and/or stores the messages sent between the devices. In some embodiments, the communications between the inventory tracking devices 110 comprise peer-to-peer communication. In some embodiments, the communication device 118 and/or a different type of communication device may allow the inventory tracking device 110 to communicate with a remote server to place orders for items.

In some embodiments, the inventory tracking devices 110 may comprise devices on a home network and/or devices within wireless communication range with each other. In some embodiments, the inventory tracking devices 110 may be loaded with a consumer identifier to authorize the device to join the inventory tracking system at the consumer premises. For example, a consumer may enter a passcode and/user ID on the inventory tracking device to add the device to the system. In some embodiments, the passcode and/or an authentication code may be included in messages transmitted between the inventory tracking devices 110 for the devices to identify messages received from a device associated with the same premises. In some embodiments, the messages may be encrypted with the consumer passcode or another encryption key to protect the privacy of broadcasted messages. In some embodiments, the messages may be encrypted with a public key and one or more of the inventory tracking devices may store a copy a private key to decrypt the messaged based on asymmetric cryptography.

In some embodiments, not all inventory tracking devices 110 in a system needs to be able to directly communicate with each other. In some embodiments, one or more inventory tracking device 110 may be configured to relay messages and/or transmit a copy of a shared ledger to another device in the system. For example, one or more of the inventory tracking devices 110 may be configured to repeat broadcasted messages it receives to other devices in its communication range. In some embodiments, the messages may contain an identifier and the inventory tracking devices 110 may be configured to recognize that the same message is being repeated using the identifier. In another example, if one inventory tracking device 110 is offline for some time, when it turns back on, it may send a query to one or more of the other inventory tracking devices 110 for a copy of the latest inventory database. In some embodiments, one or more inventory tracking devices 110 may be configured to receive a query from one of the plurality of other inventory tracking devices via the communication device 118 and respond to the query based on information stored in the memory device 114 via the communication device 118. In some embodiments, the query may comprise a request for one or more of the current estimated inventory, recent orders submitted, and recent inventory changes detected. In some embodiments, a hubless group of inventory tracking devices 110 configured for peer-to-peer communication allows any inventory tracking devices 110 to be added and/or removed from the system without affecting the remaining inventory tracking devices and eliminates the need for dedicated hub devices that need to be compatible with a plurality of different types of inventory tracking devices.

Referring now to FIG. 2, a method of tracking consumer premises inventory is shown. In some embodiments, the steps shown in FIG. 2 may be performed by a processor-based device, such as one or more of an inventory tracking device, a smart appliance, a smart sensor, a smart storage device, and the like. In some embodiments, the steps in FIG. 2 may be performed by one or more of the inventory tracking devices 110 shown in FIG. 1.

In step 201, an inventory tracking device detects a change in the inventory. In some embodiments, the change may be associated a consumer premises comprising a plurality of inventory tracking devices and/or storage spaces associated with inventory tracking devices. In some embodiments, an inventory tracking device may comprise one or more of a smart appliance, a smart shelf, a smart receptacle, and an inventory tracking attachment at a location associated with a consumer. In some embodiments, inventory changes may be detected via an inventory sensor. In some embodiments, the inventory sensor may comprise a sensor configured to detect for inventory changes associated with the consumer premises and/or a storage space monitored by the inventory sensor. In some embodiments, the inventory sensor may comprise one or more of a camera, an optical sensor, a barcode reader, a Radio Frequency Identification (RFID) reader, a weight sensor, and the like. In some embodiments, the inventory sensor may be configured to detect items added and/or removed from a space monitored by the inventory sensor. In some embodiments, the removal of an item may be detected based on the item leaving the storage space for an extended period of time. In some embodiments, the inventory sensor may be configured to detect when items are used in a space monitored by the inventory sensor. In some embodiments, step 201 may be performed by the inventory sensor 116 described with reference to FIG. 1 or a similar device.

In some embodiments, the inventory tracking device may be configured to update an inventory database based on the inventory changes detected by the inventory sensor. In some embodiments, the inventory database may comprise one or more of a shared ledger, a distributed database, and a blockchain. In some embodiments, at least some of the inventory tracking devices in a system are configured to store a blockchain comprising an inventory database recording an inventory ledger associated with the premises comprising the plurality of inventory tracking devices. In some embodiments, an inventory tracking device may be configured to send out a request to update the distributed inventory database to record a detected inventory change. In some embodiments, before or after step 201, the inventory tracking device may monitor for signals conveying inventory information and/or order information from a plurality of other inventory tracking devices and update the inventory database stored on its memory device based on signals from the plurality of other inventory tracking devices.

In step 202, the inventory tracking device determines a purchase order based on the inventory change detected in step 201. In some embodiments, the purchase order may comprise a replenish order for an item determined to be used and/or removed from the inventory of the consumer premises. For example, if a refrigerator detects that a milk carton has been removed for a period of time (e.g. over 30 minutes), the refrigerator may generate a purchase order to replace the carton of milk. In some embodiments, the purchase order may be determined based on an inventory database stored at the inventory tracking device. For example, the inventory tracking device may use the estimated inventory level of one or more items tracked by the inventory database to determine one or more items that are depleted and/or are likely to run out in the near future. The device may then generate an order to replenish the corresponding items.

In step 203, the inventory tracking device determines whether to submit the order based on communications with other inventoy tracking devices. In some embodiments, the communication with other inventoy tracking devices may comprise direct communication via a communication device. In some embodiments, the communication may comprise peer-to-peer communication between inventory tracking devices. In some embodiments, determining on whether to submit the order may be based on communications before and/or after steps 201-203. In some embodiments, an inventory tracking device may store an inventory database that keeps a record of the estimated inventory at the consumer premises and/or past ordered placed by one or more devices. In some embodiments, the inventory database may comprise a shared ledger, a distributed database, and/or a blockchain that is updated based on communications between a number of inventory tracking devices. In some embodiments, the communication with the plurality of other inventory tracking devices comprises blockchain updates configured to update the blockchain storing inventory and/or order information. In some embodiments, an inventory tracking device may determine whether to submit an order based on checking the recorded inventory of the one or more items as stored in the inventory database as updated by a plurality of devices. If sufficient inventory exists elsewhere in the consumer premises inventory, the device may determine not to submit the order in step 203. In some embodiments, the inventory tracking device may determine whether to submit an order based on checking the submitted orders recorded in the inventory database aggregated from a plurality of devices. If an item in the purchase order determined in step 202 has recently been ordered by another device, the inventory tracking device may determine to not submit a purchase order for that item. In some embodiments, a recently submitted order may comprise orders submitted within a set period of time (e.g. 1 week, 2 weeks), orders that have not been delivered, and/or orders that have not been added to the inventory.

In some embodiments, in step 203, the inventory tracking device may broadcast the purchase order determined in step 202 to a plurality of other inventory tracking devices. The inventory tracking devices may be configured to respond to broadcasted purchase orders by either confirming and/or objecting to the proposed purchase order. In some embodiments, when an inventory tracking device receives a purchase order request from another device, the inventory tracking device may be configured to check its current inventory with its inventory sensor and/or check an inventory database stored on the device to determine whether the item in the purchase order request is low on inventory and should be reordered. In some embodiments, when an inventory tracking device receives a purchase order request from another device, it may compare the purchase order request with items it has recently ordered to detect for duplicates. In some embodiments, each inventory tracking device may further be configured to check the purchase orders generated by other devices against rules for purchase orders specified in a blockchain shared by the devices. In some embodiments, the purchase rules may comprise restrictions such as maximum order size, minimum order size, item price range, preferred brands, maximum cost per period (e.g. $50 dollars every 2 days), items that can or cannot be automatically ordered, delivery options, permitted delivery dates (e.g. no deliveries whole customer is away on vacation), etc. In some embodiments, purchase rules may be configurable by customers and/or sellers. In some embodiments, when an inventory tracking device approves of a purchase order request (e.g. does not conflict with its inventory knowledge, does not duplicate a recent order, etc.) the inventory tracking device may be configured to respond with a confirmation and/or may not respond. In some embodiments, when an inventory tracking device detects an issue with a purchase order request (e.g. sufficient item in inventory, duplicates a recent order, violates purchase rules, etc.), the inventory tracking device may be configured to respond to the purchase order with an objection. In some embodiments, the inventory tracking device may broadest a received purchased order it approves to other devices for approval and may also rebroadcast any objections received back to the device making the purchase order request. In some embodiments, in step 203, the inventory tracking device may determine whether to submit the order based on whether it receives any objections from the other devices in the system. In some embodiments, the device may determine whether to submit the purchase order based on responses and/or an absence of a response from the plurality of other inventory tracking devices.

In step 204, if the system determines to submit the order in step 203, the inventory tracking device submits the purchase order to a remote server. In some embodiments, one or more inventory tracking devices may be configured to communicate with a remote server via a network such as the Internet. In some embodiments, one or more inventory tracking devices may store the credentials of a customer associated with the inventory tracking devices and may be configured to use the credentials of the customer to place orders with a remote server associated with a retailer. In some embodiments, after step 203, the inventory tracking device may further be configured to record the submitted purchase order on a locally stored purchase record and/or a shared ledger. In some embodiments, the inventory tracking devices may be configured to record purchase orders to a shared ledger (e.g. update to a blockchain) and one or more of the inventory tracking devices may be configured to submit an order including a plurality of purchase orders from a plurality of inventory tracking devices to a remote service periodically. In some embodiments, a plurality of inventory tracking devices at a consumer premises may be configured to submit orders to one or more remote servers.

In some embodiments, steps 201-204 may be repeated each time a change in the consumer premises inventory is detected by one or more inventory tracking devices associated with the consumer premises. In some embodiments, multiple instances of steps 201-204 may be carried out simultaneously on a plurality of inventory tracking devices associated with a single consumer premises.

Referring now to FIG. 3A, a method of tracking consumer premises inventory is shown. In some embodiments, the steps shown in FIG. 3A may be performed by a processor-based device, such as one or more of an inventory tracking device, a smart appliance, a smart sensor, a smart storage device. In some embodiments, the steps in FIG. 3A may be performed by one or more of the inventory tracking devices 110 shown in FIG. 1.

In step 301, an inventory tracking device detects a change in the inventory. In some embodiments, the change may be associated a consumer premises comprising a plurality of inventory tracking devices and/or storage spaces. In some embodiments, an inventory tracking device may comprise one or more of a smart appliance, a smart shelf, a smart receptacle, and an inventory tracking attachment at a location associated with a consumer. In some embodiments, inventory changes may be detected via an inventory sensor. In some embodiments, the inventory sensor may comprise a sensor configured to detect for inventory changes associated with the consumer premises and/or a storage space monitored by the inventory sensor. In some embodiments, the inventory sensor may comprise one or more of a camera, an optical sensor, a barcode reader, a Radio Frequency Identification (RFID) reader, a weight sensor, and the like. In some embodiments, the inventory sensor may be configured to detect items added and/or removed from a space monitored by the inventory sensor. In some embodiments, the removal of an item may be detected based on the item leaving the storage space for an extended period of time. In some embodiments, the inventory sensor may be configured to detect for items used in a space monitored by the inventory sensor. In some embodiments, step 301 may be performed by the inventory sensor 116 described with reference to FIG. 1 or a similar device.

In step 302, the inventory tracking device broadcasts the inventory change detected in step 301 to other inventory tracking devices. In some embodiments, the broadcast may be encrypted with a public key associated with the customer premises. Each inventory tracking device may store a copy a private to decrypt the message. In some embodiments, the broadcast may comprise a blockchain update. In some embodiments, the broadcast may comprise a direct wireless communication and/or peer-to-peer communication between a plurality of inventory tracking device. In some embodiments, the broadcast may send via a router on a home network. In some embodiments, the broadcast may identify one or more of an item associated with the change in inventory, a quantity associated with the change, a change type (e.g. item added, item removed, etc.), an inventory tracking device identifier, and/or an associated storage space identifier.

In step 304, the system updated an inventory database stored on a plurality of inventory tracking devices. In some embodiments, the inventory database may comprise a shared ledger, a distributed database, and/or a blockchain. In some embodiments, step 304 may also occur when inventory updates are received from other devices in step 303. In some embodiments, when updates are received from another device, the inventory tracking device may be configured to authenticate the update and/or verify the update is consistent with the latest inventory information. For example, if a smart refrigerator detects and records the removal of a carton of milk, a second update from a smart trash can to remove the carton of milk may be rejected as a duplicate that is removing an item no longer in the inventory. In some embodiments, the update in step 304 may comprise a blockchain update that receives the consensus of the plurality of inventory tracking devices.

In step 305, the inventory tracking device determines a purchase order. In some embodiments, the purchase order may be triggered by the inventory change detected in step 301 and/or by the inventory information stored in the shared ledger meeting a set condition after the change. For example, if the estimated inventory for a particular item the shared ledger falls below a threshold level, one or more inventory tracking devices may be triggered to determine a purchase order for that item. In another example, when an inventory tracking device detects a reduction in the inventory of an item, the inventory tracking device may be triggered to check the inventory record in the shared ledger to determine whether sufficient quantity remains at the consumer premises and generate a purchase order if replenish is needed. In some embodiments, the inventory tracking device may check the shared ledger to determine whether the same or similar items have been recently ordered by another inventory device in step 305. In some embodiments, a recently submitted order may comprise an order that has been placed but not yet delivered to the consumer premises and/or orders placed within a set period of time (e.g. 2 days, 1 week, 2 weeks, etc.). In some embodiments, the inventory tracking device may further check the determined purchase order against the purchase rules in the shared ledger and/or blockchain to determine whether the purchase order complies with the purchase rules. In some embodiments, the purchase rules may comprise restrictions such as maximum order size, minimum order size, item price range, preferred brands, maximum cost per period (e.g. $50 dollars every 2 days), items that can or cannot be automatically ordered, delivery options, permitted delivery dates (e.g. no deliveries whole customer is away on vacation), etc.

In step 306, the inventory tracking device submits the order to a remote system. In some embodiments, one or more inventory tracking devices may be configured to communicate with a remote server via a network such as the Internet. In some embodiments, one or more inventory tracking devices may store the credentials of a customer associated with the inventory tracking devices and may be configured to use the credentials of the customer to place orders with a remote server associated with a retailer. In some embodiments, the device may only submit the purchase order if an item is determined to need replenishment based on the consumer inventory database, the purchase order does not duplicate items in a recently submitted order, and/or the purchase order does not violate rules specified in the shared ledger.

In step 307, the inventory tracking device may further broadcast the submitted order to a plurality of other inventory tracking devices, and the devices may update an order record with the new order in step 308. In some embodiments, the order record database may comprise one or more of a shared ledger, a distributed database, and a blockchain. In some embodiments, the order record and the inventory database may comprise the same shared ledger, distributed database, and/or blockchain. In some embodiments, steps 307 may occur as part of step 305 and the other inventory tracking devices may be configured to validate the purchase order based on the shared ledger and/or blockchain. In some embodiments, step 306 may only occur with consensus from other inventory tracking devices associated with the same consumer premises.

In some embodiments, steps 301-308 may be repeated each time a change in the consumer premises inventory is detected by one or more inventory tracking devices associated with the consumer premises. In some embodiments, a device may periodically check the shared ledger updated in step 304 to determine whether to perform step 305 and generate a purchase order. In some embodiments, multiple instances of steps 301-308 may be carried out simultaneously on a plurality of inventory tracking devices associated with a single consumer premises.

Referring now to FIG. 3B, a method of tracking consumer premises inventory is shown. In some embodiments, the steps shown in FIG. 3B may be performed by a processor-based device such as one or more of an inventory tracking device, a smart appliance, a smart sensor, a smart storage device. In some embodiments, the steps in FIG. 3B may be performed by one or more of the inventory tracking devices 110 shown in FIG. 1.

In step 311, an inventory tracking device detects a change in the inventory. In some embodiments, the change may be associated a consumer premises comprising a plurality of inventory tracking devices and/or storage spaces associated with inventory tracking devices. In some embodiments, an inventory tracking device may comprise one or more of a smart appliance, a smart shelf, a smart receptacle, and an inventory tracking attachment at a location associated with a consumer. In some embodiments, inventory changes may be detected via an inventory sensor. In some embodiments, the inventory sensor may comprise a sensor configured to detect for inventory changes associated with the consumer premises and/or a storage space monitored by the inventory sensor. In some embodiments, the inventory sensor may comprise one or more of a camera, an optical sensor, a barcode reader, a Radio Frequency Identification (RFID) reader, a weight sensor, and the like. In some embodiments, the inventory sensor may be configured to detect items added and/or removed from a space monitored by the inventory sensor. In some embodiments, the removal of an item may be detected based on the item leaving to the storage space for an extended period of time. In some embodiments, the inventory sensor may be configured to detect items used in a space monitored by the inventory sensor. In some embodiments, step 311 may be performed by the inventory sensor 116 described with reference to FIG. 1 or a similar device.

In step 312, the inventory tracking device determines a purchase order based on the change in the inventory. In some embodiments, the purchase order may be an order to replenish items detected to be removed from the inventory in step 311. In some embodiments, one or more inventory tracking devices may aggregate the number of items removed from the inventory and only proceed to step 312 of the removed amount exceeds a threshold. In some embodiments, one or more inventory tracking devices may track the remaining inventory and proceed to step 312 only if the remaining inventory drops below a threshold.

In step 313, the inventory tracking device broadcasts the purchase order. In some embodiments, the broadcast may be encrypted with a public key associated with the customer premises. In some embodiments, the broadcast may comprise a blockchain update request. In some embodiments, the broadcast may comprise a direct wireless communication and/or peer-to-peer communication between a plurality of inventory tracking device. In some embodiments, the broadcast may send via a router on a home network. In some embodiments, the broadcast may identify one or more of an item in the purchase order, an order quantity associated with the change, an inventory tracking device identifier, and/or an associated storage space identifier.

In step 314, the device determines whether any objection is received from other inventory tracking devices. In some embodiments, one or more the inventory tracking devices of a consumer premises may be configured to respond to purchase order requests by confirming and/or objecting to the purchase order. In some embodiments, when an inventory tracking device receives a purchase order request from another device, the inventory tracking device may be configured to check its current inventory with its inventory sensor and/or check an inventory database record to determine whether the item in the purchase order request is low on inventory and should be replenished. In some embodiments, when an inventory tracking device receives a purchase order request from another device, it may compare the purchase order request with items it has recently ordered to detect for duplicated item orders. In some, each inventory tracking device may further be configured to check the purchase orders generated by other devices against rules for purchase orders specified in a blockchain and/or a shared ledger. In some embodiments, the purchase rules may comprise restrictions such as maximum order size, minimum order size, item price range, preferred brands, maximum cost per period (e.g. $50 dollars every 2 days), items that can or cannot be automatically ordered, delivery options, permitted delivery dates (e.g. no deliveries whole customer is away on vacation), etc. In some embodiments, when an inventory tracking device approves of a purchase order request (e.g. does not conflict with its inventory knowledge, does not duplicate a recent order, etc.) the inventory tracking device may be configured to respond with a confirmation and/or may not respond. In some embodiments, when an inventory tracking device detects an issue with a purchase order request (e.g. sufficient item in inventory, duplicates a recent order, violates purchase rules, etc.), the inventory tracking device may be configured to respond to the purchase order with an objection. In some embodiments, the objection message may specify the reason for the objection. For example, the objection message may identify the items that have already been ordered and/or has sufficient inventory.

In step 314, if the device that broadcasted the purchase order receives an objection, the device may cancel the purchase order and the process may return back to step 311 to detect for another change in the inventory. In some embodiments, the device may still update an inventory dataset based on the change detected even if the purchase order is objected. In some embodiments, a purchase order may be considered objected if no consensus is reached among the inventory tracking devices associated with a consumer premises. In some embodiments, the purchase order may comprise a blockchain update, and a rejection of the update by the system of inventory tracking devices at consumer premises may comprise an objection in step 314. In some embodiments, the inventory tracking device may be configured to modify the order based on responses from the other inventory tracking devices. In some embodiments, the modified order may be broadcasted again for system approval and/or be submitted to a remote seller server. For example, if another inventory tracking device indicates that one or more items have already been orders, the device may remove those items from the order and submit the modified order.

In step 314, if the inventory tracking device that broadcasted the purchase order in step 313 does not receive any objections, the device may proceed to step 315 and submit the purchase order. In some embodiments, one or more inventory tracking devices may be configured to communicate with a remote server via a network such as the Internet. In some embodiments, one or more inventory tracking devices may store the credentials of a customer associated with the inventory tracking devices and may be configured to use the credentials of the customer to place orders with a remote server associated with a retailer. In some embodiments, after step 314, the inventory tracking device may further be configured to record the submitted purchase order on a locally stored purchase record and/or an order record database. In some embodiments, the purchase order may be added to the blockchain stored at each device as each of the other inventory tracking devices validates the purchase. In some embodiments, step 314 may only occur with consensus from the inventory tracking devices associated with the same consumer premises.

In some embodiments, steps 311-315 may be repeated each time a change in the consumer premises inventory is detected by one or more inventory tracking devices associated with the consumer premises. In some embodiments, multiple instances of steps 311-315 may be carried out simultaneously on a plurality of inventory tracking devices associated with a single consumer premises.

In some embodiments, one or more inventory tracking devices such as inventor tracking devices 110 may be configured to share computing resources. For example, the capability (e.g. processing power, internet connectivity, memory storage) of one or more inventory tracking devices at a customer premises may be recorded in a distributed database. An inventory tracking device with less capability may pass a processing and/or communication task to a more capable inventory tracking device. For example, a smart trash can may detect for inventory changes with a sensor, look for a more capable device associated with the distributed database/customer premises, and pass the information to another device to process and determine whether to place an order. In some embodiments, one or more inventory tracking devices may serve as an ad hoc “hub” for the group of inventory tracking devices. The inventory tracking device serving as an ad hoc hub may change when inventory tracking devices join or leave the group of devices associated with a distributed database and/or home network. For example, one or more inventory tracking devices in a group may be configured to periodically determine which device has the highest processing capability and assign that device the role of an ad hoc hub.

In some embodiments, a system for consumer premises inventory tracking comprises a system of appliances and other devices at a customer's home or office that tracks the use of consumable products and are configured to initiate re-ordering of consumable products associated with the device and/or used by that appliance. In some embodiments, the system may comprise a local communication network (e.g., Wi-Fi, Bluetooth, etc.) with which each appliance is coupled.

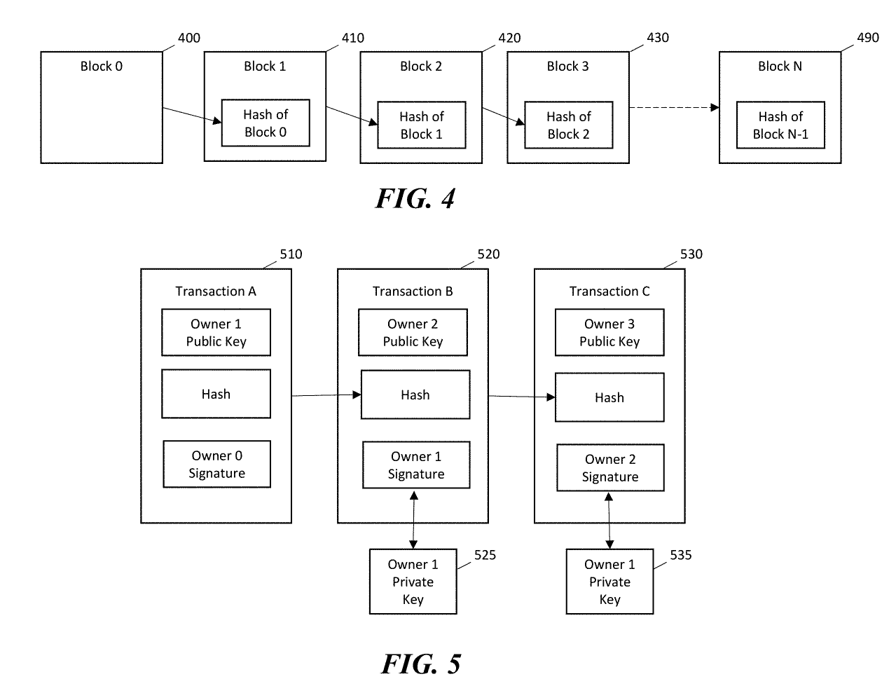

Descriptions of some embodiments of blockchain technology are provided with reference to FIG. 4-9 herein. In some embodiments of the invention described above, blockchain technology may be utilized to record inventory changes and/or submitted orders. One or more of the inventory tracking devices described herein may comprise a node in a distributed blockchain system storing a copy of the blockchain record. Updates to the blockchain may comprise an inventory change, a proposed order, and/or a submitted order and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N-1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners” are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

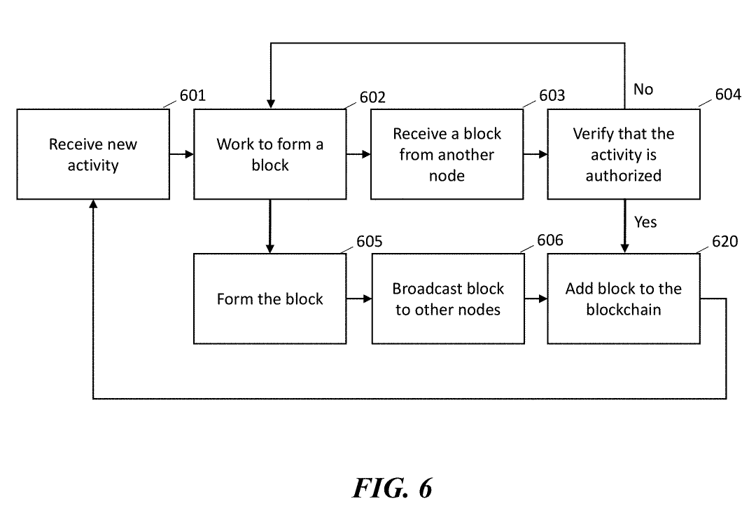

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these blocks if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

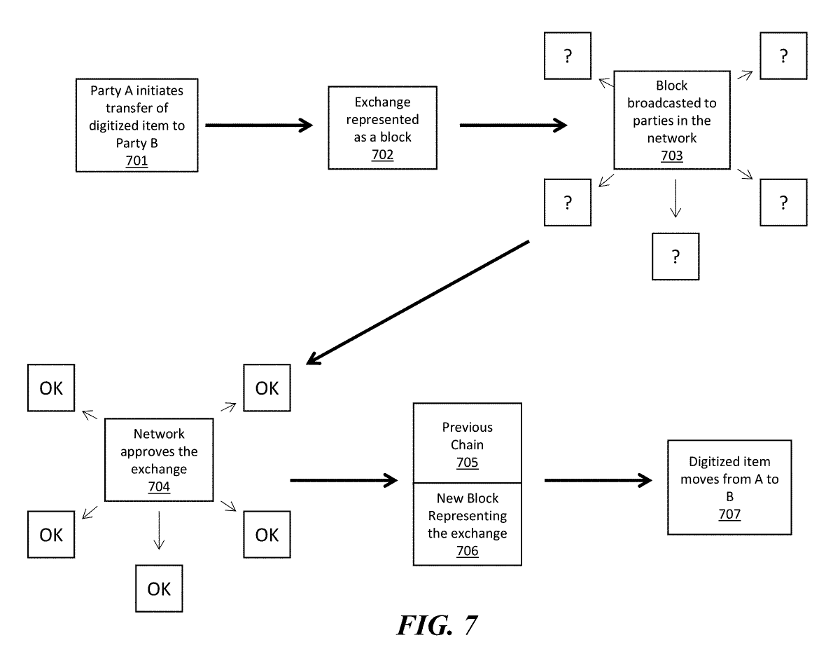

Now referring to FIG. 7, a process diagram, a blockchain update according to some implementations is shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide proof of work to form the block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

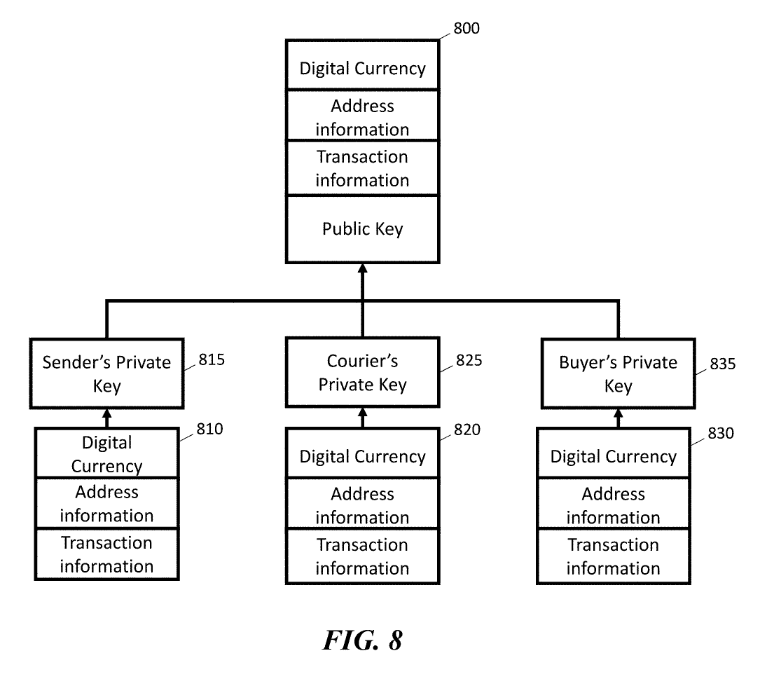

Now referring to FIG. 8, a diagram of a blockchain according to some embodiments is shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

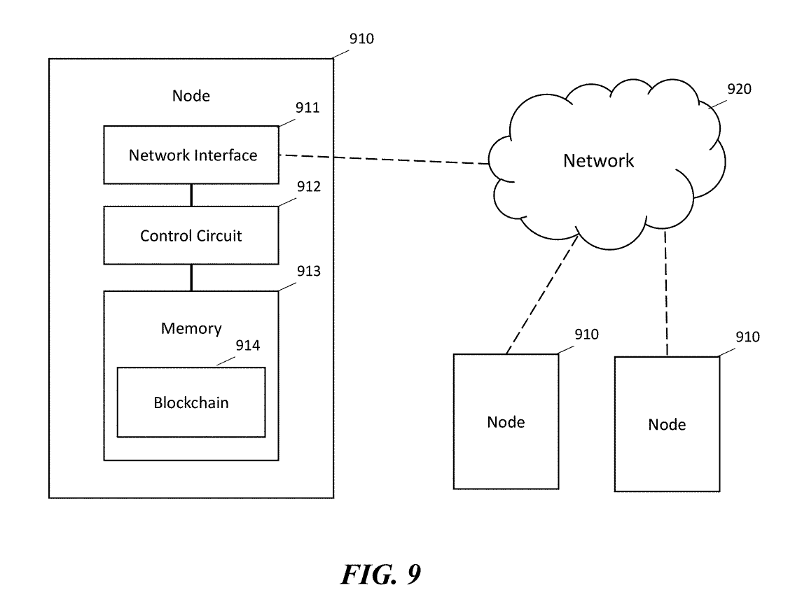

Now referring to FIG. 9, a system according to some embodiments is shown. A distributed blockchain system comprises a plurality of nodes 910 communicating over a network 920. In some embodiments, the nodes 910 may comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In one embodiment, a system for consumer premises inventory tracking comprises an inventory sensor coupled to an inventory tracking device configured to detect changes in an inventory associated a premises comprising a plurality of inventory tracking devices, a communication device configured to communicate with a plurality of other inventory tracking devices, and a control circuit coupled to the inventory sensor and the communication device. The control circuit being configured to detect a change in the inventory via the inventory sensor, determine a purchase order based on the change in the inventory, determine whether to automatically submit the purchase order to a remote server based on direct communications with the plurality of other inventory tracking devices via the communication device, and submit the purchase order to the remote server.

In one embodiment, a method for consumer premises inventory tracking comprises communicatively coupling a plurality of inventory tracking devices, detecting a change in an inventory associated with a premises comprising the plurality of inventory tracking devices via an inventory sensor coupled to an inventory tracking device, determining, with a control circuit of the inventory tracking device, a purchase order based on the change in the inventory, determining, with the control circuit, whether to automatically submit the purchase order to a remote server based on direct communications with a plurality of other inventory tracking devices via a communication device configured to communicate with the plurality of other inventory tracking devices, and submitting, with the control circuit, the purchase order to the remote server.

In one embodiment, an apparatus for consumer premises inventory tracking comprises a non-transitory storage medium storing a set of computer readable instructions; and a control circuit configured to execute the set of computer readable instructions which causes to the control circuit to: communicatively couple, via a communication device of an inventory tracking device, to a plurality of other inventory tracking devices, detect a change an inventory with a premises comprising a plurality of inventory tracking devices via an inventory sensor coupled to the inventory tracking device, determine a purchase order based on the change in the inventory, determine whether to automatically submit the purchase order to a remote server based on direct communications with the plurality of other inventory tracking devices via the communication device, and submit the purchase order to the remote server.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for consumer premises inventory tracking comprising:
an inventory sensor coupled to an inventory tracking device configured to detect changes in an inventory associated a consumer premises comprising a plurality of inventory tracking devices;
a wireless communication device configured to communicate with a plurality of other inventory tracking devices; and
a control circuit coupled to the inventory sensor and the wireless communication device, the control circuit being configured to:
detect a change in the inventory via the inventory sensor;
determine a purchase order based on the change in the inventory;
directly communicate with the plurality of other inventory tracking devices via the wireless communication device and with a broadcasted signal;
determine whether to automatically submit the purchase order to a remote server based on communications with the plurality of other inventory tracking devices; and
submit the purchase order to the remote server.

2. The system of claim 1, wherein the control circuit is further configured to:
broadcast the change in the inventory detected by the inventory sensor to the plurality of other inventory tracking devices.

3. The system of claim 1, wherein the control circuit is further configured to:
broadcast the purchase order; and
determine whether to submit the purchase order based on responses and/or an absence of a response from the plurality of other inventory tracking devices.

4. The system of claim 1, further comprising: a memory device configured to store an inventory database updated based at least on the inventory changes detected by the inventory sensor.

5. The system of claim 4, wherein the control circuit is further configured to:
monitor for signals conveying inventory information and/or order information from the plurality of other inventory tracking devices; and
update the inventory database stored on the memory device based on signals from the plurality of other inventory tracking devices.

6. The system of claim 4, wherein the control circuit is further configured to:
receive a query from one of the plurality of other inventory tracking devices via the wireless communication device; and
respond to the query based on information stored in the memory device via the wireless communication device.

7. The system of claim 6, wherein the query comprises a request for one of more of: current estimated inventory, recent orders submitted, and recent inventory changes detected.

8. The system of claim 1, wherein the communication with the plurality of other inventory tracking devices comprises blockchain updates.

9. The system of claim 1, wherein at least some of the plurality of inventory tracking devices are configured to store a blockchain comprising an inventory database recording an inventory ledger associated with the premises comprising the plurality of inventory tracking devices.

10. The system of claim 1, wherein the plurality of inventory tracking devices comprise one or more of a smart appliance, a smart shelf, a smart receptacle, and an inventory tracking attachment.

11. A method for consumer premises inventory tracking comprising:
communicatively coupling a plurality of inventory tracking devices;
detecting a change in an inventory associated with a consumer premises comprising the plurality of inventory tracking devices via an inventory sensor coupled to an inventory tracking device;
determining, with a control circuit of the inventory tracking device, a purchase order based on the change in the inventory;
directly communicating with the plurality of other inventory tracking devices via a wireless communication device and with a broadcasted signal; determining, with the control circuit, whether to automatically submit the purchase order to a remote server based on communications with a plurality of other inventory tracking devices; and
submitting, with the control circuit, the purchase order to the remote server.

12. The method of claim 11, further comprising:
broadcasting the change in the inventory detected by the inventory sensor to the plurality of other inventory tracking devices.

13. The method of claim 11, further comprising:
broadcasting the purchase order; and
determining whether to submit the purchase order based on responses and/or an absence of a response from the plurality of other inventory tracking devices.

14. The method of claim 11, wherein the inventory tracking device further comprises: a memory device configured to store an inventory database updated based at least on the inventory changes detected by the inventory sensor.

15. The method of claim 14, further comprising:
monitoring for signals conveying inventory information and/or order information from the plurality of other inventory tracking devices; and
update the inventory database stored on the memory device based on signals from the plurality of other inventory tracking devices.

16. The method of claim 14, further comprising:
receiving a query from one of the plurality of other inventory tracking devices via the wireless communication device; and
responding to the query based on information stored in the memory device via the wireless communication device.

17. The method of claim 16, wherein the query comprises a request for one of more of: current estimated inventory, recent orders submitted, and recent inventory changes detected.

18. The method of claim 11, wherein the communication with the plurality of other inventory tracking devices comprises blockchain updates.

19. The method of claim 11, wherein at least some of the plurality of inventory tracking devices are configured to store a blockchain comprising an inventory database recording an inventory ledger associated with the premises comprising the plurality of inventory tracking devices.

20. The method of claim 11, wherein the plurality of inventory tracking devices comprise one or more of a smart appliance, a smart shelf, a smart receptacle, and an inventory tracking attachment at a location.

21. An apparatus for consumer premises inventory tracking comprising:
a non-transitory storage medium storing a set of computer readable instructions; and
a control circuit configured to execute the set of computer readable instructions which causes to the control circuit to:
communicatively couple, via a wireless communication device of an inventory tracking device, to a plurality of other inventory tracking devices;
detect a change an inventory with a premises comprising a plurality of inventory tracking devices via an inventory sensor coupled to the inventory tracking device;
determine a purchase order based on the change in the inventory;
directly communicate with the plurality of other inventory tracking devices via the wireless communication device and with a broadcasted signal;
determine whether to automatically submit the purchase order to a remote server based on communications with the plurality of other inventory tracking devices; and
submit the purchase order to the remote server.
